(19) United States
(12) Patent Application Publication
(10) Pub. No.: US 2023/0023836 A1
(43) Pub. Date: Jan. 26, 2023

(54) System And Method For Providing Real-Time Online Human Or Human-Equivalent Assistance

(71) Applicants: Adam Charles Rubin, Long Beach, CA (US); Gary Jack Kramer, Los Angeles, CA (US)

(72) Inventors: Adam Charles Rubin, Long Beach, CA (US); Gary Jack Kramer, Los Angeles, CA (US)

(21) Appl. No.: 17/383,139

(22) Filed: Jul. 22, 2021

(51) Int. Cl. G06Q 30/00; G06Q 30/02; H04L 29/08; H04L 29/06

(52) U.S. Cl. CPC G06Q 30/01; G06Q 30/0206; H04L 67/025; H04L 67/42

(57) ABSTRACT

The present invention is related to a network-based system and method for real-time online human or human-equivalent assistance that allows a user to connect with an online helper in real-time, wherein the online helper assists the user in doing things, both on or offline, including using apps of a personal digital device with or without the click of a button, searching, getting information, transacting, communicating, emoting, connecting with others, getting expertise, learning, multi-tasking, navigating the digital world, and much more. The network-based system comprising a mobile/web-based application for the personal digital device having a program and circuitry, is installed by the user and online helper in their respective personal digital devices for the real-time online interaction, creating a peer-to-peer connection therebetween via a server and the Internet. This provides new hope for many to be able to do a wide range of things, both on and offline, more easily.

### BACKGROUND OF THE INVENTION

### Field of the Art

The system and method of the present invention relates to the field of online assistance technology and related business platforms. More particularly the system and method of the present invention relates to the field of providing real-time online human or human-equivalent assistance to a user of a personal digital device, wherein the user is someone who is struggling to use app-based technology and feels disconnected from his/her loved ones or human connection, is someone who cannot access his/her personal digital device due to the inability to focus, type, or text (e.g. while driving) safely on different apps, or is someone who needs access to help, support, information and expertise he/she cannot get on his/her own.

### Discussion of the State of the Art

This advancement in digital technology and business model results in more complex functional capability for a huge group of people via smartphones, computers, tablets, personal digital assistants, etc. (digital devices) which may not be adaptable by everyone, especially technologically-challenged older people over 50 years old. Due to the complexities of apps, a huge number of people (e.g. seniors/older people) are not able to use the vast majority of apps on their smartphones, tablets and computers. This includes shopping, searching, scheduling, communicating, getting emotional and technical support, getting technical and other assistance, ride-sharing and many others. Also, many people have difficulty typing or texting (especially seniors/older people) and many seniors/older people are constantly forgetting passwords and other login information. Moreover, the families and friends of these seniors/older people suffer from immense frustration and time loss in attempting to help them use the app-based technologies.

A few prior arts have been disclosed which describe providing online help platform. One of the prior arts, U.S. Ser. No. 10/725,801B2, discloses a method of interaction between a user and live help where “a live human agent or an automated helper” points to a portion of a user's screen. The agent may direct the user to various components, located on or off of the user's graphical user interface, by pointing to a feature either on or outside of the user's GUI. The agent or the agent's interface is capable of processing or identifying the geographical locations of the physical features outside of the user's display area, without needing to view the physical features. Therefore, the system may be referred to as “geographical live support.”

The above-mentioned prior art discusses providing interaction between a single user and live helper where the two parties communicate with each other by visually referencing the physical specific locations of the two parties that are communicating through a screen. The prior art mainly describes a helper being able to assist a user with respect to a singular device or system, and does not disclose anything about providing assistance via different digital applications, using a range of features & functions of the personal digital devices themselves, and also does not address the way that many people can use a system and capability to engage in a range of simultaneous and non-simultaneous actions between them. Hence, there is a need to invent a system and method which particularly focuses on these wide ranging digital human interactions to occur on a singular or large scale and for many simultaneous and non-simultaneous actions.

Another prior art, CN101237327A, discloses an online assistance platform system and realization method wherein there is at least one seeking-for-help party device and at least one help party device. The online help information includes images and operational information, word messages, pictorial information, voice messaging, and video information and files etc. The prior art does not disclose anything regarding a live online concierge/helper and/or live human face-to-face assistance. It is only restricted to limited screen pointing and annotation. Also, the prior art does not disclose anything about providing assistance in using different digital applications or incorporating different features and functions of the personal digital devices themselves. And the prior art does not mention a business system related to it.

Furthermore, the above-mentioned prior arts do not disclose multiple problems that can be addressed with the possibility of a system of online live human or human-equivalent assistance. This includes automobile drivers and customer service. Driving & texting or driving & working on one's phone is incredibly dangerous. There is a need for a way for people to remain productive while driving. The system of the present invention helps with the aforesaid need. In addition, a chatbot for customer service is not super-efficient as it typically requires far more understanding than current artificial intelligence (AI) can provide. Despite the desire for current AI to help people with their needs, it often seems to come up short versus a human being in terms of authentically providing appropriate and in-depth solutions given the current level of technology.

Despite the complexity of the above-mentioned prior conventional arts, they do not describe providing instant and real-time online human or human-equivalent assistance, nor are they specifically tailored towards providing assistance with usage of various digital applications or features & functions of the personal digital devices themselves. Additionally, the conventional arts do not describe accessing live human or human-equivalent support without the click of a button. Furthermore, the conventional arts do not provide adequate solutions to drivers for multi-tasking using digital devices while driving safely. The conventional arts also do not overcome limitations associated with chatbots. The unique characteristics and features of the system and method of the present invention are therefore unrepresented within the prior arts.

The aforesaid conventional arts encounter various shortcomings. Hence, there is a significant need and void in the market for inventing a system and a method which provides real-time online human or human-equivalent assistance to the users of personal digital devices, including those who struggle to use technology and feel disconnected from their loved ones due to lack of knowledge in how to use various Apps or features & functions of their personal digital devices.

The applicant is unaware of the existence of any such method and system providing real-time online human or human-equivalent assistance as an online helper that address the above described shortcomings in the prior arts. More specifically, there is no such network-based system and method known in the prior art that allows a user to connect with the online helper in real-time to assist the user in using online digital applications (Apps) on personal digital devices. Furthermore, no such system exists where the user can connect with the online helper without the click of button. In addition, no existing system of online assistance provides a method for helping people do things on their smartphones/digital devices while performing other activities, such as, but not limited to driving. Furthermore, no such system exists to establish online face-to-face human or human-equivalent support in real-time for online customer service platforms. Additionally, such system can ultimately be used 24 hours a day/7 days a week (24/7) based on this system, to take care of any needs that can be performed by the online helper per the online user's request.

Furthermore, the applicant is unaware of any such method or system whereby the online helper providing real-time human assistance can then refer the user needing assistance to another online helper who has expertise in the field the user is requesting assistance.

### SUMMARY OF THE INVENTION

The main object of the present invention is to overcome the problem associated with traditional online assistance systems by providing a network-based system and method for real-time online human or human-equivalent assistance that allows a user to connect with an online helper in real-time, wherein the online helper assists the user in using a personal digital device with or without the click of a button.

Accordingly, the inventor has conceived and reduced to practice, in a preferred embodiment of the invention, the network-based system and method for real-time online human or human-equivalent assistance comprising a two-sided platform in the form of a mobile/web-based application for people who need help and the people or human-equivalent digital creations who provide help, which transforms the way that a huge segment of the global population, especially for people over age of 50 interact with digital technology, primarily on devices such as a smartphone, tablet or computer. The present invention introduces a novel system and method for personal digital devices having a program and circuitry for the real-time online interaction between the user and the online helper, wherein the online helper assists the user with anything that can be done with the personal digital device including, but not limited to shopping, communicating, travel booking, rideshares booking, prescription filling, emergencies, database searching, help with solving a variety of problems, and the need for expertise in a particular area to solve more technical and specific problems etc. In addition, the present invention helps people dealing with physical and emotional issues, such as loneliness or depression, and solves real world problems, such as issues around the house including, but not limited to, plumbing or using movie programs like Netflix. The system of the present invention comprises the mobile/web-based application accessible via Internet, to run via the personal digital device including, but not limited to smartphones, computers, wearable devices, tablets, i-Pads or other mobile computing devices.

According to the present invention, the mobile/web-based application is installed by the user and the online helper in their respective personal digital devices, wherein the mobile/web-based application requires signing up by the user and the online helper to have access to the real-time online human assistance platform. Once signed up, the user can open the mobile/web-based application by just clicking on the application icon and then the user is able to gain instant live access to the available online helper that offers assistance with a number of things online. The mobile/web-based application of the present invention can also be integrated with a “virtual assistant” (e.g. Apple's Siri) of the personal digital device, hence if the user attempts to ask/say a word or phrase such as “online assistance”, “need live assistance”, “online help”, “need live help,” “need live person”, or something relevant, then the virtual assistant automatically transfers the user to the mobile/web-based application (App) of the present invention. In this way, the user can access the mobile/web-based application without the click of a button. The user is connected to a server via the Internet, wherein the system software is hosted. The server connects the user to the available online helper and enables a peer-to-peer connection between them via the Internet.

The main purpose of the present invention is to provide a new hope for non and limited technology users to be able to access the thousands of digital applications (Apps) on their personal digital devices. In addition, the present invention also assists these users with a wide variety of both physical and emotional problems, including loneliness and depression, while providing a respite for friends and family members to resolve a massive “pain point”—having to help these people. This “pain point” takes up a huge amount of time and causes tremendous frustration for helpers and those receiving help. Therefore, this real-time online human or human-equivalent assistance system and method of the present invention provides multi-fold benefits for a wide range of people which are described in the following pages of specification.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram of a functional architecture for a network-based system for real-time online human or human-equivalent assistance, according to an embodiment of the present invention.

FIG. 2 illustrates an exemplary flow diagram of a sign-up process by a user, wherein the user registers with a mobile/web-based application, according to an embodiment of the present invention.

FIG. 3 illustrates an exemplary flow diagram of a sign-up process by an online helper, wherein the online helper registers with a mobile/web-based application, according to an embodiment of the present invention.

The figures are described in greater detail in the next section of the patent specification.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

It is to be also understood that the phraseology and terminology employed herein is for the purpose of description and not of limitation.

It is to be understood that the term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

### Definitions

As used herein the following terms have the meaning given below:

“User”—means any person who is registered with a system of the present invention, and needs assistance with respect to the usage or functioning of a personal digital device.

“Human assistant”—means any human who is registered with a system of the present invention, and provides online human assistance in real-time to the user.

“Human-equivalent assistant”—means cognitive artificial intelligence (AI) resembling human intelligence which is incorporated in a system of the present invention to provide online human-equivalent assistance in real-time to the user.

“Online helper”—means any human assistant and/or human-equivalent assistant who is associated with a system of the present invention to provide online help or online assistance in real-time to the user.

“Personal digital device”—means any computing device that combines communication gateway and computing functions into one unit i.e. smartphones, computers, wearable devices, tablets, i-Pads or other mobile computing devices.

“User device”—means any personal digital device owned by a user on which a mobile/web-based application is installed.

“Online helper device”—means any personal digital device owned/used by a human assistant or controlled by a human-equivalent assistant on which a mobile/web-based application is installed.

“Central server” or “server”—means, in a preferred embodiment, an entity comprising a computer hardware or software program that provides functionality for other programs or the devices, wherein the program adapted to implement a system and a method for managing interaction between a user device and an online helper device.

### Detailed Description of Exemplary Embodiments

The following description is presented to enable one skilled in the art to make and use the invention, and is provided in the context of particular applications and their requirements. Various modifications to the disclosed embodiment will be apparent to those skilled in the art, and the general principals set forth below may be applied to other embodiments and applications. Thus, the present invention is not intended to be limited to the embodiments shown and the inventor regards this invention as any patentable subject matter described herein.

The present invention discloses a network-based system and method for real-time online human or human-equivalent assistance that allows a user to connect with an online helper in real-time, wherein the online helper assists the user in using a personal digital device with or without the click of a button. The online helper assists the user with anything that can be done with the personal digital device. The network-based system of the present invention comprises a two-sided platform in form of a mobile/web-based application accessible via the Internet, to run by a plurality of user devices and a plurality of online helper devices.

Reference will now be made in detail to a presently preferred embodiment of the invention, an example of which is illustrated in the accompanying drawings.

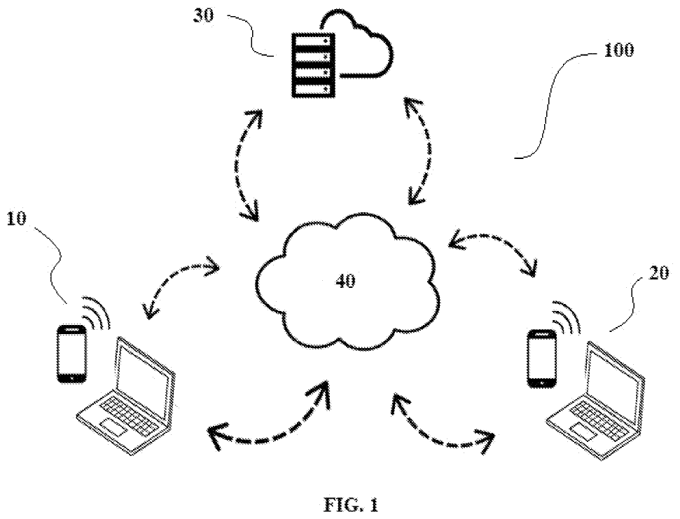

According to an exemplary embodiment of the present invention, a functional architecture of the network-based system 100 for the real-time online human or human-equivalent assistance is shown in FIG. 1. Referring to FIG. 1, the network-based system 100 is based on alternative payment systems (e.g. per minute and monthly subscription-based models) depending on the needs of the user, wherein the network-based system 100 comprising at least one user device 10 from the plurality of user devices including at least a processor and a memory, at least one online helper device 20 from the plurality of online helper devices including at least a processor and a memory, a server 30 (or a plurality of servers) wherein a system software is hosted, and the Internet 40 to establish a communication between the user device 10, the online helper device 20, and the server 30.

Further referring to FIG. 1, the user installs the mobile/web-based application in the user device 10 and signs in as the user via a user facing gateway, wherein an initial connection to the server 30 is made via the Internet 40. Similarly, the online helper installs the mobile/web-based application in the online helper device 20 and signs in as the online helper via an online helper facing gateway. Upon assistance request by the user, the server 30 connects the user to the online helper via the Internet 40, and enables a peer-to-peer connection therebetween. The system software hosted by the server 30 is developed using system programming methodologies and systems programming languages, and designed specifically to execute a program for the mobile/web-based application of the present invention. The network-based system 100 stores and manages all the information inputted by the user and the online helper. Furthermore, a plurality of additional users would be queued up and follow the same pattern of the user facing gateway. Also, a plurality of additional online helpers would be queued up and follow the same pattern of the online helper facing gateway.

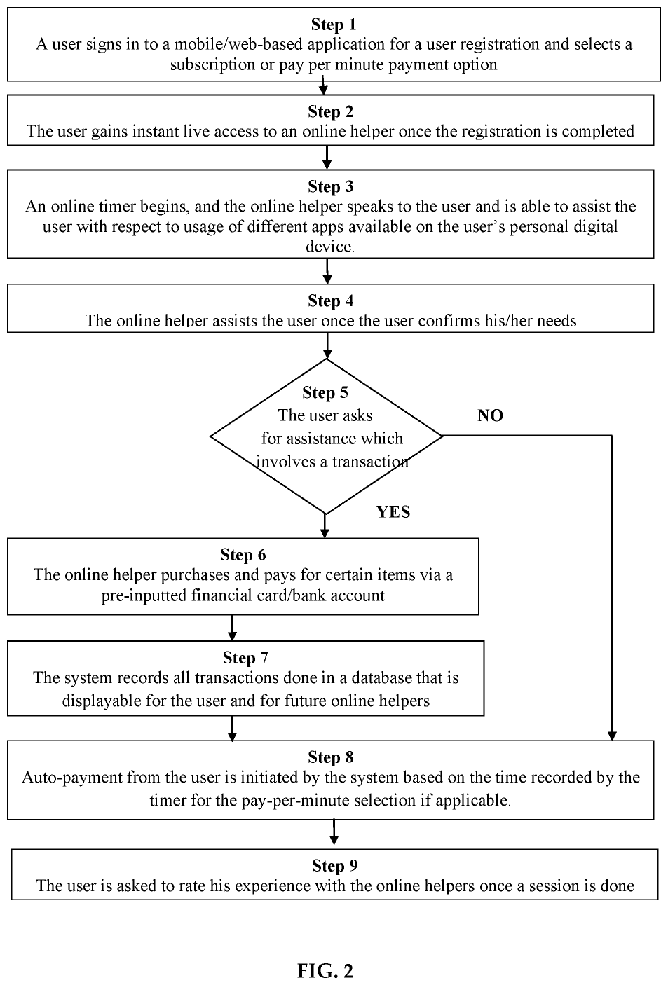

According to various embodiments of the present invention, a several process steps of the network-based system 100 are shown in FIGS. 2 & 3. The mobile/web-based application installed on the user device 10 includes the user facing gateway that the user will be using to interact with the online helper to have assistance from him. The user facing gateway comprises a plurality of sequential steps to be accomplished by the user as shown in FIG. 2. Referring to FIG. 2, at an input step 1 in starting with the process, the user registers himself as the user by signing in to the mobile/web-based application, and selects a monthly subscription option or a pay-per-minute payment option. Signing in, is often a one-time task, which can either be done by the user, or for the user by the online helper who is waiting live who logs in for the user and can also register for the user the first time they join the platform. While registration, the user might need to provide personal information and financial payment details for the purpose of various payments i.e. payment for shopping, payment to the online helper for his service, etc. The financial payment details is highly secured by the network-based system 100, and only available to limited centralized transaction coordinators.

At step 2, once the user is in the mobile/web-based application after registration, he is able to gain instant live access to the online helper that offers assistance with a number of things online. Further at step 3, an inbuilt digital timer starts, and the online helper approaches the user and asks about any assistance the user may need with respect to usage or functioning of different apps available on the user device 10 or user's personal digital device. The online helper is able to assist the user use different apps for transaction, travel booking, prescription filing, emergencies, searching browser, entertainment, rideshare, direction and navigation, message and communication, media share and transfer, screen personalization, apps and windows, emoting and many more things the user may desire. The online helper may also assist with any emotional or physical requirements or needed solutions that the user may require. This might even be unrelated to any app in particular, such as, but not limited to, providing technical or other assistance or coordinating with a 3^{rd} party to assist with such assistance. At step 4, the online helper provides assistance to the user once the user confirms the apps/tasks he need assistance with.

Further at step 5, if any apps/tasks for which the user has asked for assistance which involve transactions, then the process would move forward to further steps 6 & 7. And, if any apps/tasks for which the user has asked for assistance which do not involve transactions, then the process would skip steps 6 & 7 and move forward to step 8.

In case the apps/tasks for which the user has asked for assistance which involve transactions, then at step 6, the online helper makes purchase and pays for the purchase using the financial payment details submitted by the user during registration. For instance, the user inputs some information into a database on the online helper's end, i.e. item SKU numbers, flight dates, times, specific airlines, and prices. From there, the required needs of the user are instantly made available to the transaction coordinator at a central location. The transaction coordinator orders the requested items using the mobile/web-based application's own corporate accounts and then bill the user and/or certain family members once transactions have been placed. The users' financial information may be unavailable to the individual online helper around the world. The centralized transaction coordinators may be the sole people with access to any financial information of the user. Further at step 7, the network-based system 100 records all the transactions done in a database that is displayable for the user and for the future online helpers.

At step 8, the network-based system 100 initiates an auto-payment for the pay-per-minute selection from the user based on the time recorded by the inbuilt digital timer of the mobile/web-based application. The inbuilt digital timer is located on a graphical user interface of the user device 10. Further at final step 9, the network-based system 100 asks the user to rate his experience of using service of the online helper once a session is completed. The rating system will create an average score based on all the different users the online helper has helped.

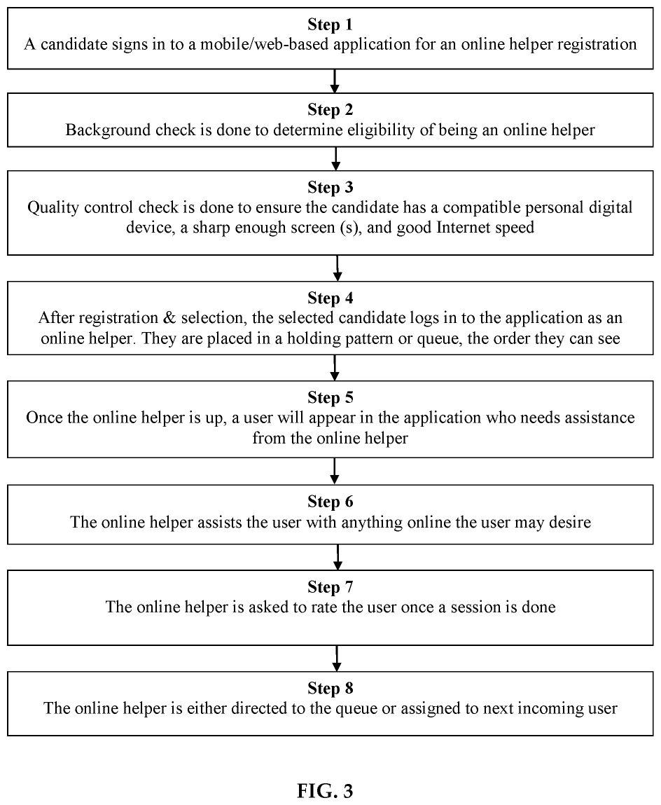

According to abovementioned embodiment of the present invention, the mobile/web-based application installed on the online helper device 20 includes the online helper facing gateway that the online helper will be using to interact with the user to provide assistance to the user. The online helper facing gateway comprises a plurality of sequential steps to be accomplished by the online helper as shown in FIG. 3. Referring to FIG. 3, at an input step 1, a candidate registers himself as the online helper or a human assistant by signing in to the mobile/web-based application. While registering, the candidate might need to submit his personal identification information. Further, the candidate might need to submit the information about the type of computer system he has. At step 2, a background check is done and an online interview is conducted by a third party entity, to determine the eligibility and capability of the candidate. Further at step 3, a quality check is done for candidate's personal digital device with respect to operating system, monitor, webcam, etc., hence to ensure the candidate has compatible personal digital device to efficiently accomplish the job of the online helper. Also, internet speed is assured for uninterrupted service from the candidate.

Proceeding towards step 4, once the candidate is selected and his registration is confirmed, he needs to sign in and/or log in to the mobile/web-based application. After signing in, the selected candidate as the online helper will go into a holding pattern or queue. At step 5, when the online helper is up for providing assistance, the user would appear on his graphical user interface and he will be able to help the user. When the user appears, the online helper will be able to see the information of the user including, but not limited to the user's prior shopping and transaction history. Further at step 6, the online helper assists the user with anything online the user has asked for, such as different apps of the personal digital device for transaction, travel booking, prescription filling, emergencies, searching browsers, entertainment, rideshare, directions and navigation, messages and communication, media share and transfer, screen personalization, apps and windows, emoting, any physical or emotional requests, referrals to other helpers for help with particular required expertise, and many more things the user may desire. The online helper will be able to share his graphical user interface with the user in a way that is customized for optimum viewing, primarily on the smartphone.

At step 7, the network-based system 100 asks the online helper to rate the user once a session is completed. The network-based system 100 then tracks and determines the average score of the user from all the ratings. At step 8, after completing one session, the online helper may directed to the online helper queue or may be assigned to the next incoming user.

In the online helper-facing gateway, after logging in, the online helpers can see and review their average ratings on the graphical user interface of their devices. The online helpers can also see their online status, how much time they have been online and for how long. The online helpers can also see their earning and tips. Further, when the online helpers join the queue, their turn to provide help is determined based on an algorithm of their rating and the number of users in waiting. The network-based system will let them know if there's a wait and how long. Moreover, the online helpers are credited a bonus on defined time for getting others to join the network-based system.

In this way, the online helper gateway of the network-based system enables people to make ends meet from home or on the go. The online helper gateway provides an opportunity to make money from anywhere in the world.

Also the online helper can direct the user to another online helper for additional assistance (including technical), or bring in that online helper into the communication.

According to an embodiment of the present invention, accessing the mobile/web-based application can be very simple by integrating it with a “virtual assistant” (e.g. Apple's Siri) of the personal digital device, hence if the user attempts to ask/say a word or phrase such as “online assistance”, “need live assistance”, “online help”, “need live help,” “need live person”, or something relevant, then the virtual assistant automatically transfers the user to the mobile/web-based application of the present invention. In this way, the user can have the access to the mobile/web-based application without the click of button. The mobile/web-based application can also be accessed by just clicking the app icon, clicking one button within the app if it is open, or merely by going to the website URL.

The network-based system and method of the present invention for real-time online human or human-equivalent assistance is highly advantageous over the traditional online assistance systems. The network-based system is unique in a number of ways as it solves a problem that many people don't have the ability to use digital-based technology to do a range of things or don't have the time to be able to do this for oneself. The system of the present invention mainly focuses on elderly people, but it can also feasible for the drivers to stay productive while driving. The network-based system can be used as stand-alone, but can also be integrated with other online applications and marketplaces. For example, when someone needs customer service help and they arrive at a page of the mobile/web-based application of present invention and the online helper appears on the page. The network-based system of present invention represents a way for people to re-connect with the human or human-equivalent side of things. With the system of present invention, people no longer have to worry about how they or their loved ones will be able to transact, search, find information and directions, use ride share, and communicate without any technical knowledge. In addition, the system offers a wide range of people from all walks of life the opportunity to make a living wage as an online helper from home or anywhere they choose. There will also be additional wage opportunities for engineers and programmers tasked with creating and managing human-equivalent AI compatible with this system. There are also a range of ancillary markets and opportunities that will grow from this system. The present invention is here to simplify and enhance the lives of many.

While certain embodiments of the inventions have been described, these embodiments have been presented by the way of example only, and are not intended to limit the scope of the disclosure. Indeed, the novel methods and system described herein may be embodied in a variety of other forms; furthermore, various omissions, substitutions and changes in the form of the methods and systems herein may be made without departing from the spirit of the disclosure. The accompanying claims and their equivalents are intended to cover such forms or modifications as would fall within the scope and spirit of the inventions.

The skilled person will be aware of a range of possible modifications of the various embodiments described above and many other possible applications of the present invention may be reduced to practice. Therefore, the present invention is not limited by the specific embodiments described above. Accordingly, the present invention is defined by the claims and their equivalents.

1. A network-based system for real-time online human or human-equivalent assistance, comprising:
a plurality of user devices having a mobile/web-based application, wherein the mobile/web-based application comprising a user-facing gateway for a plurality of users, wherein a first user, with the first user being associated with at least one user device, signs in to the mobile/web-based application via the user-facing gateway;
a plurality of online helper devices having the mobile/web-based application, wherein the mobile/web-based application comprising an online helper-facing gateway for a plurality of online helpers, wherein a first online helper with the first online helper being associated with at least one online helper device signs in to the mobile/web-based application via the online helper-facing gateway;
a server to connect the first user to the first online helper via the Internet to enable a peer-to-peer connection there between, upon assistance request by the first user, wherein the server hosts the system software which is developed using system programming methodologies and systems programming languages and is designed specifically to execute a program for the mobile/web-based application.

2. The network-based system for real-time online human or human-equivalent assistance as claimed in claim 1, wherein the system stores and manages all the information inputted by the first user and the first online helper.

3. The network-based system for real-time online human or human-equivalent assistance as claimed in claim 1, wherein a plurality of additional users are queued up and follow the same pattern of the user facing gateway.

4. The network-based system for real-time online human or human-equivalent assistance as claimed in claim 1, wherein a plurality of additional online helpers are queued up and follow the same pattern of the online helper-facing gateway.

5. The network-based system for real-time online human or human-equivalent assistance as claimed in claim 1, wherein the mobile/web-based application can be integrated with a virtual assistant of a personal digital device.

6. A network-based method for real-time online human or human-equivalent assistance, wherein a plurality of users sign up to a mobile/web-based application for a user registration via a plurality of user devices, wherein each user device, comprising at least a processor and a memory, and wherein the network-based method for real-time online human assistance comprising the steps of:
deploying a server, wherein the server hosts system software developed using system programming methodologies and systems programming languages, and designed specifically to execute a program for the mobile/web-based application;
signing in to the mobile/web-based application by a first user for a user registration, and selecting a payment option, such as a monthly subscription, pay-per-minute/amount of time, or other options;
gaining instant live access to a first online helper once the user registration is done by the first user;
approaching the first user by the first online helper to assist the first user with a number of things online;
providing assistance to the first user by the first online helper once the first user confirms the apps/tasks he needs assistance with;
making purchase and payment by the first online helper, if the apps/tasks for which the first user has asked assistance involve transactions;
recording all the transactions done in a database that is displayable for the first user and for a plurality of future online helpers;
initiating an auto-payment if the first user has selected the pay-per-minute/amount of time option, wherein the time is recorded by an inbuilt digital timer;
rating the first online helper by the first user, based on his experience of using service of the first online helper, once a session is completed.

7. The network-based method for real-time online human or human-equivalent assistance as claimed in claim 6, wherein the signing in can be done by the first user, or for the first user by the first online helper.

8. The network-based method for real-time online human or human-equivalent assistance as claimed in claim 6, wherein the inbuilt digital timer starts when the first online helper approaches the first user.

9. The network-based method for real-time online human or human-equivalent assistance as claimed in claim 6, wherein the first online helper assists the first user with using a plurality of apps including, but not limited to transactions, travel booking, prescription filling, emergencies, searching browsers, entertainment, rideshare, direction and navigation, messages and communication, media sharing and transfer, screen personalization, apps and windows, any physical and emotional needs, and needs for expertise and assistance in any areas, both technical and non-technical.

10. The network-based method for real-time online human or human-equivalent assistance as claimed in claim 6, wherein the financial details of the first user is only accessed by a designated centralized transaction coordinator.

11. A network-based method for real-time online human or human-equivalent assistance, wherein a plurality of online helpers sign up to a mobile/web-based application for an online helper registration via a plurality of online helper devices, wherein each online helper device comprising at least a processor and a memory, and wherein the network-based method for real-time online human or human-equivalent assistance comprising the steps of:
deploying a server, wherein the server hosts a system software developed using system programming methodologies and systems programming languages, and designed specifically to execute a program for the mobile/web-based application;
signing in to the mobile/web-based application by a candidate for an online helper registration;
checking background and taking online interview of the candidate by a third party, to determine the eligibility and capability of the candidate;
quality checking of a personal digital device of the candidate to ensure the candidate has compatible personal digital device to efficiently accomplish the job of an online helper;
selecting the candidate as a first online helper, wherein the first online helper needs to log in to the mobile/web-based application, and forming an online helper queue;
providing assistance by the first online helper when a first user appears on his graphical user interface;
rating the first user by the first online helper, based on his experience with the first user, once a session is completed;
directing the first online helper to the online helper queue or assigning to the next incoming user.

12. The network-based method for real-time online human or human-equivalent assistance as claimed in claim 11, wherein the candidate might be a human who has applied to work as the online helper to provide online human assistance to the user or a human-equivalent entity.

13. The network-based method for real-time online human or human-equivalent assistance as claimed in claim 11, wherein the candidate needs to submit his personal identification information and the information about the type of his computer system, while the online helper registration.

14. The network-based method for real-time online human or human-equivalent assistance as claimed in claim 11, wherein the quality checking is done with respect to operating system, monitor, webcam, and internet speed of the personal digital assistance of the candidate.

15. The network-based method for real-time online human or human-equivalent assistance as claimed in claim 11, wherein the first online helper can share his graphical user interface with the first user in a way that is customized for optimum viewing.

16. The network-based method for real-time online human or human-equivalent assistance as claimed in claim 11, wherein the first online helper can direct the first user to another online helper for additional assistance or bring in that online helper into the communication.

17. The network-based method for real-time online human or human-equivalent assistance as claimed in claims 6 & 11, wherein the network-based system tracks and determines the average score of the first user and the first online helper, from all the respective ratings.
